(19) United States
(12) Patent Application Publication
(10) Pub. No.: US 2013/0052839 A1
(43) Pub. Date: Feb. 28, 2013

(54) DETACHABLE CONNECTION STRUCTURE

(71) Applicant: Akito IWAMA, Chiryu-ciy (JP)

(72) Inventor: Akito IWAMA, Chiryu-ciy (JP)

(73) Assignee: DENSO CORPORATION, Kariya-city (JP)

(21) Appl. No.: 13/553,016

(22) Filed: Jul. 19, 2012

(30) Foreign Application Priority Data
Aug. 30, 2011 (JP) 2011-187030

(51) Int. Cl. H01R 24/00

(52) U.S. Cl. 439/8

(57) ABSTRACT

A connection structure which electrically connects, through a conductive ball, a first contact which is provided at an electrical wiring member and a second contact which is provided at an electrical component, wherein a bottom surface of a case is provided with a ball assembly-use passage, the first contact is provided at the electrical wiring member facing the ball assembly-use passage.

### TECHNICAL FIELD

The present invention relates to a detachable connection structure with which electrical contacts can slide with respect to each other.

### BACKGROUND ART

As seen in Japanese Unexamined Patent Publication No. 2002-052924, electrical and electronic parts in control units are being increasingly integrated and massed together. By closely packing a plurality of electrical and electronic parts for modularization on a circuit board which is integrally mounted in a circuit board case, costs are being reduced, the number of cables in wire harnesses are being cut, space is being saved, and the number of assembly steps is being reduced. In this trend toward space saving, actuators and other parts are being directly attached to circuit boards without going through cables so as to reduce the wire harness.

In recent years, along with such a reduction in the wire harness, remarkable progress has been made in the reduction of the size of the actuators thereby enabling space to be saved. However, at the connecting parts of circuit boards with power lines or signal lines of actuators etc., soldering, press fitting, and other hard-to-detach connection methods are still being used. For this reason, for example, even if the ECU breaks down, it is necessary to also discard actuators and other parts besides the ECU. To solve this problem, US2003/0090147A1 discloses the prior art of connecting electrical contact parts with each other through the separate parts comprised of conductive springs, without using soldering or other difficult to detach connection methods, so as to enable the actuators and ECUs to be easily separated.

This prior art uses a spring element as a conductor to connect a contact surface of a contact of a circuit board and a contact surface of a contact of a pressure sensor. The contact surface of the contact of the circuit board and the contact surface of the contact of the pressure sensor are elastically held and electrically connected by the spring element. For this reason, the electronic control unit can be easily attached to and detached from other parts. However, the spring element is plated with a precious metal against the contact sliding wear due to the difference in linear expansion coefficient which occurs when the product is subjected to repeated cooling and heating (hereinafter referred to as “cooling and heating cycles”). For this reason, the problem arose that the cost became higher.

From the above, in connection members for attachment and detachment of connecting parts, a structure which absorbs height variations at the time of assembly and enables easy attachment and detachment has been sought. Suppression of the increase in contact electrical resistance due to the contact sliding wear which occurs at the time of cooling and heating cycles of products has also been sought.

### SUMMARY OF INVENTION

The present invention, in consideration of the above problems, provides a detachable connection structure with which electrical contact parts can slide with each other.

To solve the above problem, the aspect of the invention of claim 1 provides a connection structure which electrically connects, through a conductive ball, a first contact which is provided at an electrical wiring member and a second contact which is provided at an electrical component, the connection structure is provided with a case, the electrical wiring member which is placed inside of the case while separated from the bottom of the case by a predetermined distance, the conductive ball, and the electrical component, wherein a bottom surface of the case is provided with a ball assembly-use passage, the first contact is provided at an electrical wiring member facing the ball assembly-use passage, and, when the electrical component is fastened in the case, in the ball assembly-use passage, the conductive ball is pressed and held between the first contact and the second contact whereby the first contact and the second contact are electrically connected.

Due to this, even if one part of two electrical contact parts malfunctions, since solder or other hard-to-detach connections are not used, the two (for example, an actuator and ECU) can be easily separated. Further, even if relative displacement of the first contact and second contact occurs due to the difference in linear expansion coefficient which arises at the time of cooling and heating cycles of the product, the ball used as the connecting member (conductive ball) rolls, so contact sliding wear is suppressed and thick plating in anticipation of wear becomes unnecessary.

The aspect of the invention of claim 2 comprises the aspect of the invention of claim 1 characterized in that the ball assembly-use passage has a bowl-shaped slanted surface in which the conductive ball is placed. Due to this, at the time of assembly, positioning of the conductive ball when placing it becomes easy and assembly becomes simple.

The aspect of the invention of claim 3 comprises the aspect of the invention of claim 2 characterized in that when fastening the electrical component to the case, a positioning member is provided between the case and the electrical component so that the conductive ball rises up from the slanted surface of the ball assembly-use passage. Due to this, even if relative displacement of the first contact and second contact occurs due to the difference in linear expansion coefficient which arises at the time of cooling and heating cycles of the product, the conductive ball freely rolls, so contact sliding wear is suppressed.

The aspect of the invention of claim 4 comprises the aspect of the invention of claim 1 characterized in that the second contact is formed at a recessed surface.

The aspects of the invention of claims 5 and 6 comprise the aspect of the invention of claim 1 characterized in that the electrical wiring member is a printed circuit board or a bus bar. Of course, it may also be a combination of these.

The aspects of the invention of claims 7 to 9 comprise the aspect of the invention of claim 1 characterized in that the electrical component is an actuator, sensor, or choke coil. Of course, it may also be a combination of these.

The aspect of the invention of claim 10 comprises the aspect of the invention of claim 1 characterized in that the second contact is provided at a connector terminal.

The aspects of the invention of claims 11 and 12 are comprised of the aspect of the invention of claim 1 characterized in that the conductive ball is a shaped part of conductive rubber, plastic, metal, or sheet metal or the conductive ball is a shaped part of nonconductive rubber, plastic, metal, or sheet metal which given a conductive plating or a coating of a conductive metal material.

The aspects of the invention of claims 13 and 14 are comprised of the aspect of the invention of claim 11 or 12 characterized in that the conductive ball is hollow. If making the conductive ball hollow, the strength is determined by the diameter and the thickness of the hollow shell (strength becomes plateau stress), so design of the parameters in the strength design for preventing the board side from deforming or breaking becomes easy.

The aspect of the invention of claim 15 comprises the aspect of the invention of claim 1 characterized in that the conductive ball is comprised of a ball-shaped core member, which vaporizes at a high temperature, which is coated with a conductive metal material, then heated to make the center part of the core member vaporize and simultaneously sinter the metal material which is coated on the outer circumference.

The aspect of the invention of claim 16 comprises the aspect of the invention of claim 1 characterized in that the first contact or second contact or both the first and second contacts are elastically supported. Due to this, the pressing and sliding of the conductive ball with respect to the first and second contacts become reliable and the reliability is improved.

### BRIEF DESCRIPTION OF DRAWINGS

These and other objects and features of the present invention will become clearer from the following description of the preferred embodiments given with reference to the attached drawings, wherein:

FIG. 1 is an explanatory view which explains one embodiment of the present invention.

FIG. 2A is an explanatory view of setting a terminal element at a circuit board, while FIG. 2B and FIG. 2C are respectively modifications of one embodiment of the present invention showing a first contact and a second contact.

FIGS. 3A to 3E are explanatory views which explain one example of the method of assembly of one embodiment of the present invention.

FIGS. 4A and 4B are explanatory views which explain one example of a means for transporting a conductive ball.

FIGS. 5A to 5C are explanatory views which explain the behavior of a conductive ball at the time of assembly and after assembly.

FIG. 6 is an explanatory view which explains another embodiment of the present invention.

FIG. 7 is an explanatory view which explains another embodiment of the present invention.

FIG. 8 is an explanatory view which explains another embodiment of the present invention.

FIG. 9A is an explanatory view which explains another embodiment of the present invention, while FIG. 9B to FIG. 9D are explanatory views of the position and sliding state of a conductive ball.

### DESCRIPTION OF EMBODIMENTS

The present invention is a connection structure which electrically connects, through a conductive ball 50, a first contact 152 which is provided at an electrical wiring member 30 and a second contact 13 which is provided at an electrical component. It proposes a detachable connection structure which is able to allow sliding of the contact parts. As the connecting parts between contacts which are applied to, connecting parts between an ECU (electronic control unit) and a power line or signal line of a connector or actuator or a choke coil or other large part or connecting parts of bus bars etc. may be mentioned, but the invention is not limited to these. The “electrical wiring member” indicates a printed circuit board, bus bar, etc. Further, the “electrical component” includes a drive motor, sensor, choke coil, and all other components which have electrical contacts. Even hydraulic motors and other fluid pressure devices are included here as “electrical components” if including a control valve, HCU (hydraulic control unit), or other electrical component.

Below, while referring to the drawings, embodiments of the present invention will be explained. In the embodiments, parts of the same configuration are assigned the same reference signs and their explanations omitted.

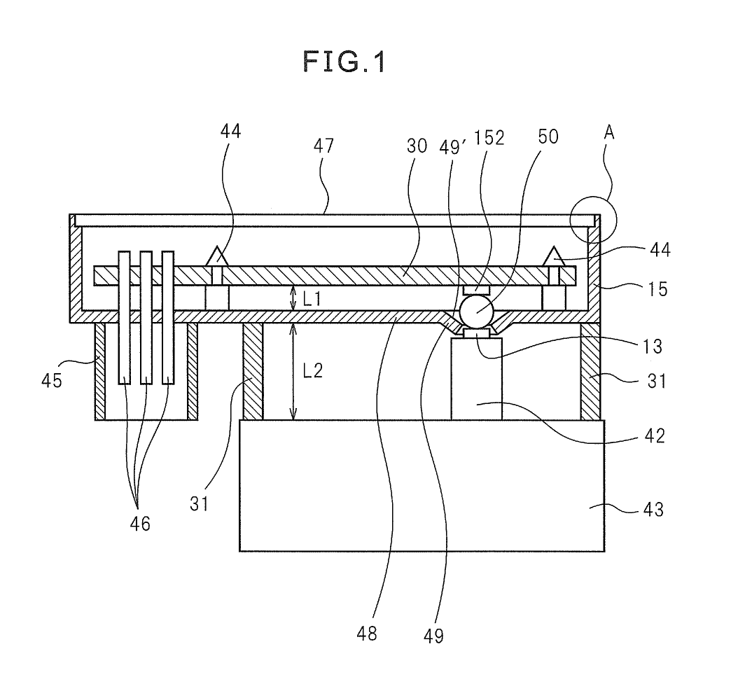

FIG. 1 is an explanatory view which explains one embodiment of the present invention. As one example, one embodiment of the present invention is explained for the case where the electrical wiring member 30 is a printed circuit board. The case 15 here is a board case. A circuit board 30 on which a microcomputer comprised including a CPU, memory, or other functional parts and other semiconductor devices are arranged is placed inside the board case. As one specific example of such a board case, an ECU which is attached to an air-conditioning unit described in Japanese Unexamined Patent Publication No. 2002-052924, a control device comprised of an electronic control unit and pressure sensor coupled together of US2003/0090147A1, etc. may be mentioned, but the invention is not limited to this. Any component in which a circuit board 30 etc. is placed inside of a board case 15 may constitute one embodiment of the present invention.

The circuit board 30 is set separated from a bottom surface 48 of the board case 15 by a predetermined distance L1 and is fastened to the board case 15 by snap fitting 44, 44. Instead of snap fitting 44, 44, screwing, swaging, etc. may also be used. The board case 15 has a connector 45 attached to it. Connector terminals 46 are connected to the board by soldering or press fitting. The connector is set at the outside of the bottom surface of the board case 15, but may be suitably set in any direction.

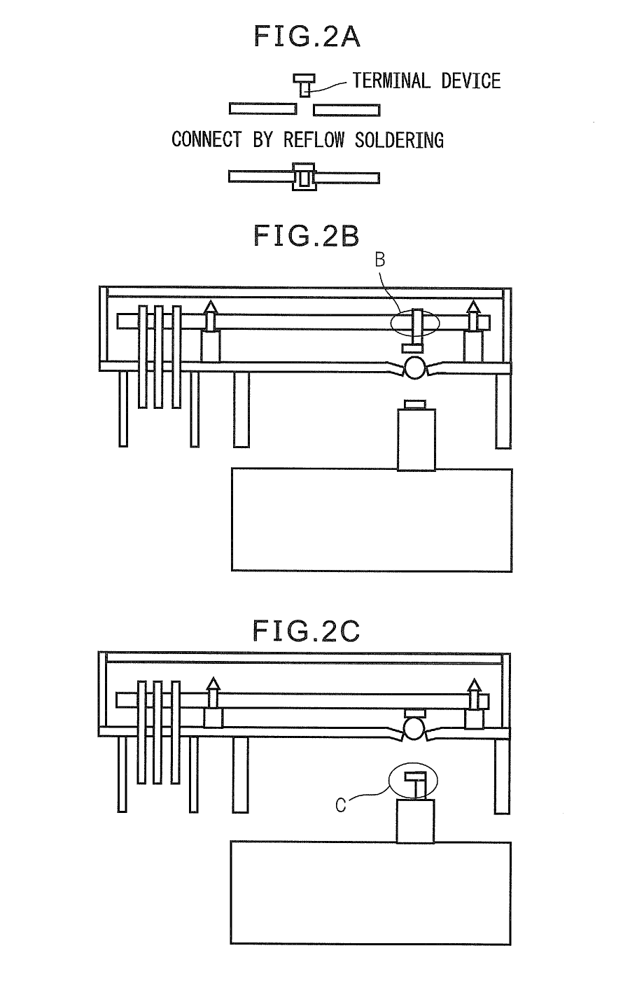

On the circuit board 30, while not shown, an IC or other electronic or electrical components are mounted. At the bottom surface 48 of the board case 15, a ball assembly-use passage 49 is provided. A first contact 152 is provided at the bottom side of the circuit board 30 facing the ball assembly-use passage 49. To set the first contact 152 at the circuit board 30, not only is it possible to directly set it on the surface patterns, but it is also possible to attach a terminal device as a separate part to the circuit board 30 by a mounter in a through hole provided in the board and solder it by reflow soldering. FIG. 2A is an explanatory view of placement of a terminal device on a circuit board, FIG. 2B shows a modification of the present embodiment where a bus bar B which has a first contact is connected to a through hole which is provided in a circuit board 30, and FIG. 2C shows a modification of the present embodiment of connection of a bus bar C which has a second contact set at an actuator 42.

When fastening an electrical component (as one example, an actuator) 42 to the board case 15, at the ball assembly-use passage 49, the conductive ball 50 is pressed and held between the first contact 152 and the second contact 13 of the actuator 42 whereby the first contact 152 and the second contact 13 are electrically connected. The actuator 42 is fastened to the housing 43 by swaging etc. The ball assembly-use passage 49 is comprised of a through hole which is somewhat smaller than the ball diameter so that the conductive ball 50 does not drop through it. A bowl-shaped slanted surface 49′ in which the conductive ball 50 is placed is provided at the hole rim for positioning of the conductive ball 50.

As shown in FIG. 1, the distance between the housing 43 of the actuator 42 and the board case 15 is set to L2. Positioning members 31 are provided so that the distance accurately is set to L2 when fastening the two. The positioning members 31 are set at the board case 15 side in the present embodiment, but may also be set at the housing 43 side of the actuator 42 and may be eliminated if able to be replaced by something corresponding to the positioning members 31. When the actuator 42 is fastened to the board case 15, the distance between the first contact 152 and the second contact 13 has to be accurately set with respect to the diameter of the conductive ball 50 so that the conductive ball 50 is pressed against and functions as a contact. When the conductive ball 50 is a ball-shaped elastic member, the distance between the first contact 152 and the second contact 13 may be generally somewhat smaller than the diameter of the conductive ball 50.

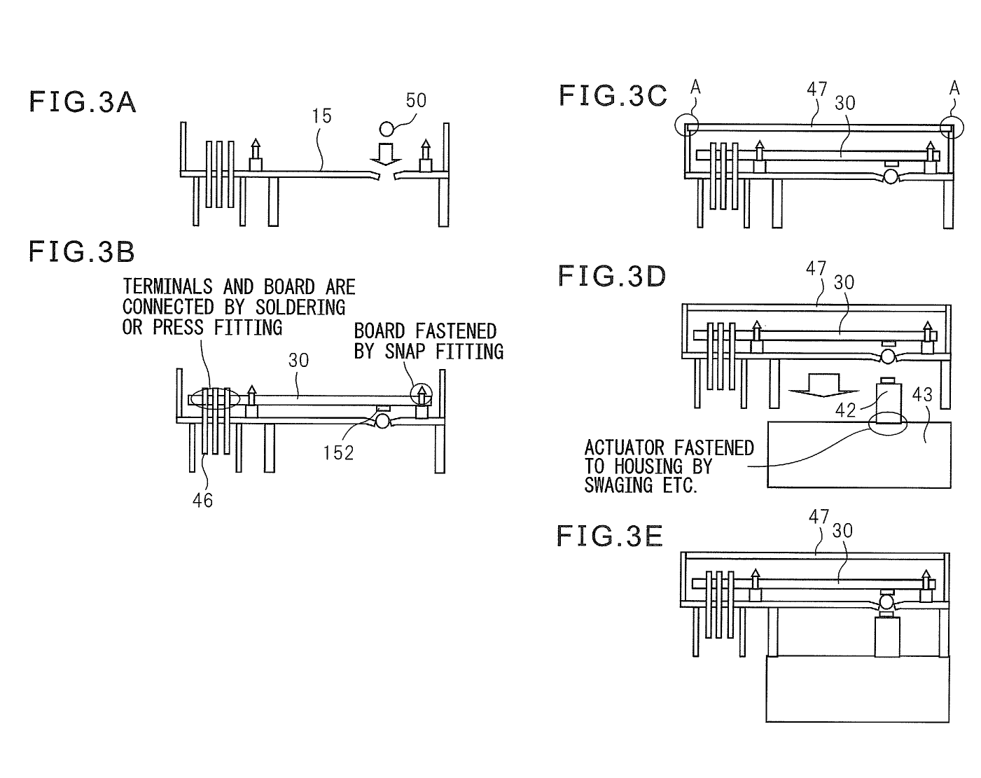

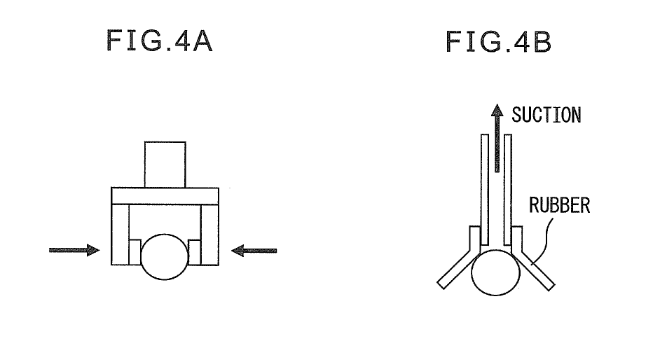

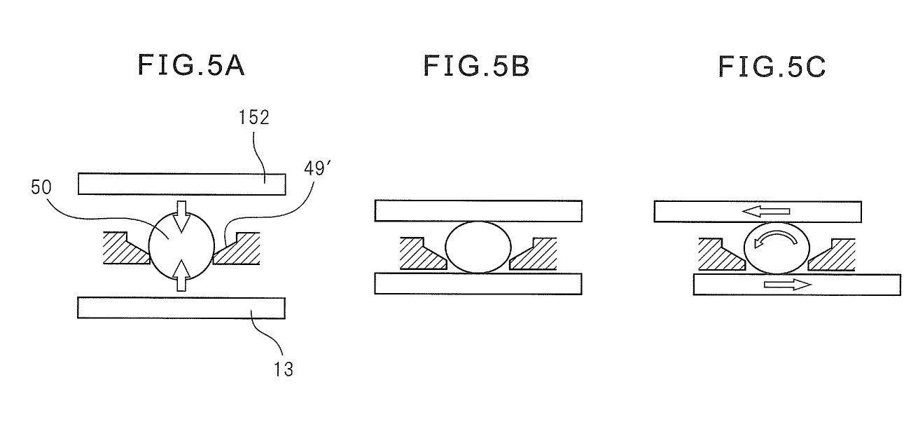

FIGS. 3A to 3E are explanatory views which explain one example of the method of assembly of one embodiment of the present invention. FIGS. 4A and 4B are explanatory views which explain one example of means for transporting the conductive ball. FIGS. 5A to 5C are explanatory views which explain the behavior of a conductive ball 50 at the time of assembly and after assembly. Below, one example of the method of assembly of one embodiment of the present invention will be explained.

(1) Assembly of Ball Into Board Case (see FIG. 3A)

First, in the ball assembly-use passage 49 of the board case 15, a robot hand chuck part such as in FIG. 4A, a suction means of FIG. 4B, etc. is used to place the conductive ball 50. If the robot hand chuck part is a rigid body, it may cause the ball to deform, so an elastic member made of rubber etc. is set at the chuck part for the transport. When using a suction means to place the conductive ball 50, a suction device with a front end made of rubber picks up ball 50, transports it to right above the assembly part, and drops it there. The ball assembly-use passage 49 is formed with a through hole which is somewhat smaller than the ball diameter so as to prevent the conductive ball 50 from dropping through it. A bowl-shaped slanted surface 49′ is provided at the hole rim for positioning the conductive ball 50. The placed state is shown in FIG. 5A.

(2) Assembly and/or Connection of Board In Board Case (see FIG. 3B)

Next, the circuit board 30 is fastened by press fitting 44 and the connector terminal 46 is connected to the circuit board 30 by soldering, press fitting, etc. At this point of time, a clearance is formed between the first contact 152 and the top end of the conductive ball 50, so the conductive ball 50 and the first contact are not connected.

(3) Assembly and Connection of Cover (see FIG. 3C)

A cover 47 is fit into the board case 15, then the parts A of FIG. 3C are joined by a binder, laser welding, or vibration welding.

(4) Assembly of Covered Case at Housing (see FIG. 3D)

The joined cover 47 and board case 15 are attached to a housing 43 to which an actuator 42 is fastened by swaging etc. The attaching means uses the not shown bolts etc. Before attaching the board case 15 to the housing 43, the conductive ball 50 is positioned at the bowl-shaped slanted surface 49′, but after assembly, the conductive ball 50 leaves the board case 15 and is sandwiched between an upper plate (first contact 152) and a lower plate (second contact 13).

(5) Connection of Board Contact and Actuator Contact (see FIG. 3E)

When the actuator 42 is fastened to the board case 15, the distance between the first contact 152 and the second contact 13 has to be set with respect to the diameter of the conductive ball 50 so that the conductive ball 50 is pressed against. The first contact 152 and the second contact 13 have to function as contacts. The second contact 13 at the actuator side lifts up the conductive ball 50 and simultaneously presses against and contacts the first contact 152 at the board side. The state at this time is shown in FIG. 5B. The conductive ball 50, it should be noted, is designed to rise up from the slanted surface 49′ of the ball assembly-use passage 49. For this reason, as shown in FIG. 5C, even if the first contact 152 and the second contact 13 shift to the left or right, the conductive ball 50 can freely rotate.

The action and effects of the conductive ball 50 of the present embodiment will be explained. At the time of cooling and heating cycles of a product, the difference in linear expansion coefficient of the members causes relative displacement of the first contact 152 and the second contact 13. In this case, even if relative displacement occurs, the ball used as the connecting member (conductive ball 50) rolls, so contact sliding wear can be suppressed and thick plating in anticipation of wear becomes unnecessary. At the time of deformation in the board case height direction due to the cooling and heating cycles, since the conductive ball 50 has a higher strength than the circuit board 30, the board side may deform and/or break. However, if making the conductive ball 50 hollow, the strength is determined by the diameter and the thickness of the hollow shell (plateau stress), so it becomes easy to set patterns in the strength design so that the board side does not deform and/or break. When the conductive ball 50 is a ball-shaped elastic member, there is no such problem. The diameter of the conductive ball 50 (both solid and hollow) is, considering the transport, about 1 to 5 mm.

Here, the method of production of the conductive ball 50 will be explained.

The conductive ball 50 may be produced by the following method in the case of a ball shaped member.
(1) Injection molding of conductive rubber and/or plastic as material.
(2) Shaping by casing and sintering using conductive metal as material.
(3) Plating a conductive material on a molded part made of nonconductive rubber, plastic, or metal.

In the case of a hollow ball-shaped member,
(4) Joining two molded semicircular parts made of conductive rubber, plastic, or metal.
(5) Bending conductive metal sheet.
(6) Coating a ball-shaped core member, which vaporizes at a high temperature, with a conductive metal material, then heating to make the center part vaporize and simultaneously sinter the outer circumference coating material. In this case, the vaporized gas escapes from clearances of the powder to the outside, then the coating material at the outer circumference is sintered.
(7) Plating a conductive material on a product obtained by joining two molded semicircular parts made of nonconductive rubber, plastic, and metal.

In addition to this as well, various other methods of production may be considered. These are covered by the above embodiment of the present invention.

As other embodiments of the present invention, the following such modifications may be considered.

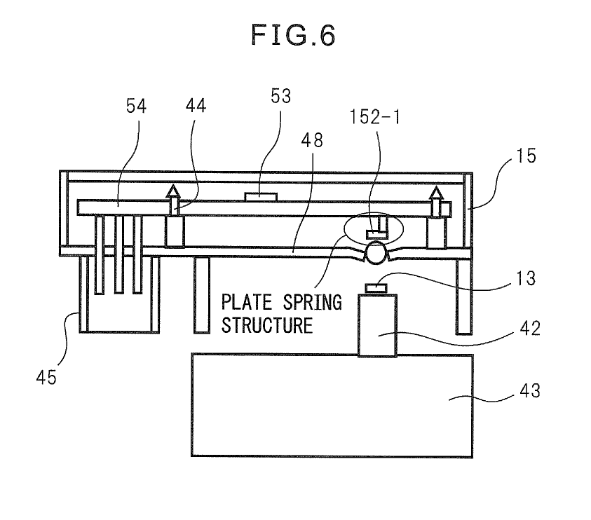

FIG. 6 is an explanatory view which explains another embodiment of the present invention. In this other embodiment, as the wiring member 30, a bus bar 54 is selected. Inside the case 15, an IC chip 53 etc. are connected to the bus bar 54. The bus bar 54 is set separated from the bottom surface 48 of the case 15 by a predetermined distance L1 and is fastened to the case 15 by snap fitting 44, 44. Regarding the rest, this is similar to the case of the above embodiment. The above-mentioned modifications etc. may also be similarly applied. In this example, the first contact 152-1 is elastically supported by the plate spring structure. The first contact 152-1 itself may be formed by a plate spring. Alternatively, the support column which supports it may be a spring structure. In addition, in the above embodiment of the present invention as well, the first contact 152 or the second contact 13 or both the first and second contacts may be elastically supported.

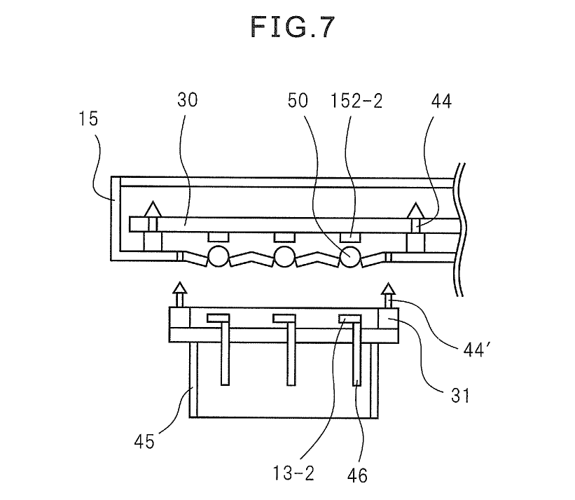

FIG. 7 is an explanatory view which explains another embodiment of the present invention. In this other embodiment, the electrical component is a connector 45. The connector terminals 46 differ from the case of the above embodiment in that they are not press fit, but are connected through conductive balls 50 to a plurality of first contacts 152-2 which are provided at the circuit board. On the other hand, the second contacts 13-2 are provided at the tops of the connector terminals 46. The positioning members 31 are provided at the connector 45 side. Snap fittings 44′ are used to attach the connector 45 to the case 15 (screws or other means may be used for attachment as well). The connector 45 need not be attached to the case 15 and may also be attached to the circuit board 30. Regarding the rest, the embodiment of FIG. 7 is similar to the case of the previous embodiment. The above-mentioned modifications etc. may also be similarly applied.

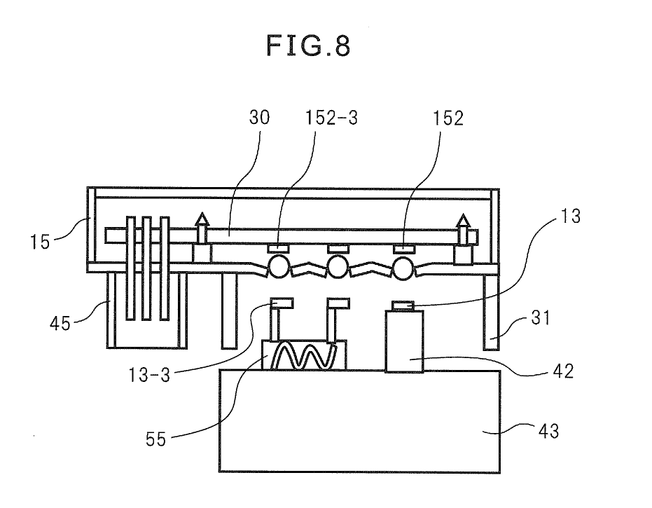

FIG. 8 is an explanatory view which explains another embodiment of the present invention. In this other embodiment, a choke coil 55 or other large electrical component is set at the housing 43. The choke coil 55 is provided with second contacts 13-3. The corresponding first contacts 152-3 are set at the circuit board 30. Regarding the rest, the embodiment of FIG. 8 is similar to the case of the previous embodiment. The above-mentioned modifications etc. may also be similarly applied.

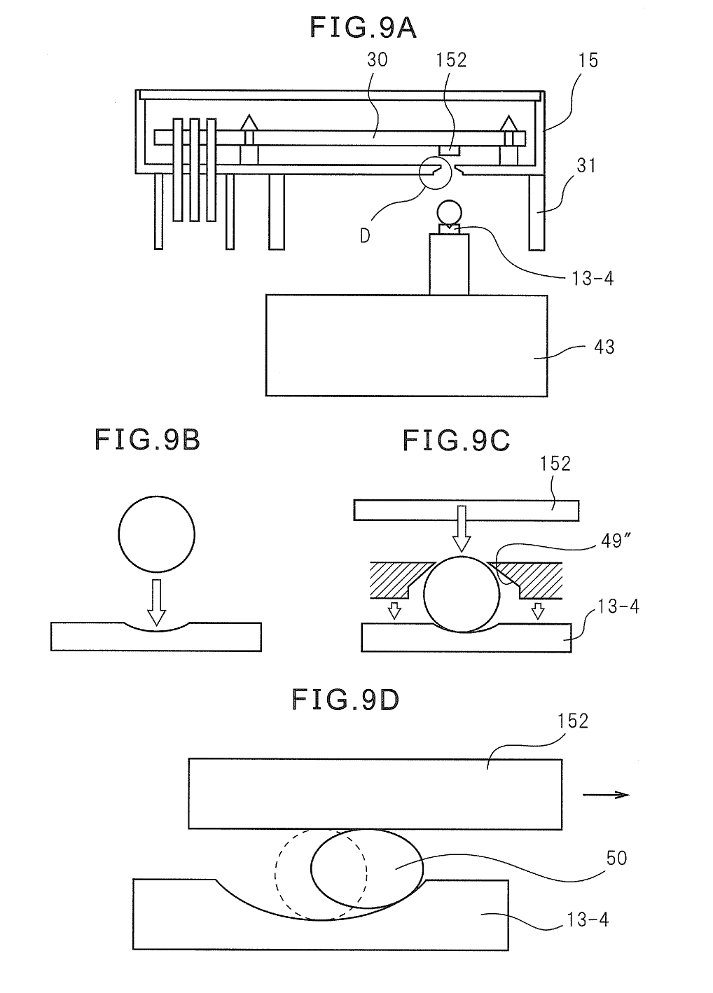

FIG. 9A is an explanatory view which explains another embodiment of the present invention, while FIG. 9B to FIG. 9D are explanatory views of the positioning of the conductive ball and sliding state. In this other embodiment, the ball contact surface of the second contact 13-4 is formed in a recessed surface. The recessed part may be formed by a smooth curve like a concave lens, but may also be a bowl-shaped conical surface with a gentle slant. The conductive ball need only be positioned and placed at the second contact 13-4.

If the ball assembly-use passage 49 is, as shown by the part D of FIG. 9A, formed with a slanted surface 49″ opposite to the previous embodiment, even if positional deviation occurs, the conductive ball 50 can be corrected to the position of the first contact 152 at the time of assembly. At the time of completion of assembly, the first contact presses the conductive ball 50 (in case of elastic member) down to make it elastically deform and break the contact of the conductive ball 50 from the slanted surface 49″. It is also possible to not use a slanted surface 49′, but set the diameter of the ball assembly-use passage 49 larger than the diameter of the conductive ball 50, but in this case, at the time of assembly, the case 15 and the housing 43 have to be accurately positioned and fastened so that the conductive ball 50 is not assembled at the position of the first contact 152.

In the present embodiment, when relative displacement of the first contact 152 and the second contact 13-4 occurs due to the difference in linear expansion coefficient, contact sliding wear can be suppressed since the conductive ball 50 rolls as in FIG. 9D. However, in this case, the conductive ball 50 is formed by a ball-shaped elastic member.

While the invention has been described by reference to specific embodiments chosen for purposes of illustration, it should be apparent that numerous modifications could be made thereto by those skilled in the art without departing from the basic concept and scope of the invention.

1. A connection structure which electrically connects, through a conductive ball, a first contact which is provided at an electrical wiring member and a second contact which is provided at an electrical component,
the connection structure provided with a case, said electrical wiring member which is placed inside of the case while separated from the bottom of the case by a predetermined distance, said conductive ball, and said electrical component, wherein
a bottom surface of said case is provided with a ball assembly-use passage,
said first contact is provided at an electrical wiring member facing the ball assembly-use passage, and,
when said electrical component is fastened in said case, in said ball assembly-use passage, said conductive ball is pressed and held between said first contact and said second contact whereby said first contact and said second contact are electrically connected.

2. A connection structure as set forth in claim 1, characterized in that said ball assembly-use passage has a bowl shaped slanted surface in which said conductive ball is placed.

3. A connection structure as set forth in claim 2, characterized in that when fastening said electrical component to said case, a positioning member is provided between said case and said electrical component so that said conductive ball rises up from the slanted surface of said ball assembly-use passage.

4. A connection structure as set forth in claim 1, characterized in that said second contact is formed at a recessed surface.

5. A connection structure as set forth in claim 1, characterized in that said electrical wiring member is a printed circuit board.

6. A connection structure as set forth in claim 1, characterized in that said electrical wiring member is a bus bar.

7. A connection structure as set forth in claim 1, characterized in that said electrical component is an actuator.

8. A connection structure as set forth in claim 1, characterized in that said electrical component is a sensor.

9. A connection structure as set forth in claim 1, characterized in that said electrical component is a choke coil.

10. A connection structure as set forth in claim 1, characterized in that said second contact is provided at a connector terminal.

11. A connection structure as set forth in claim 1, characterized in that said conductive ball is a shaped part of conductive rubber, plastic, metal, or sheet metal.

12. A connection structure as set forth in claim 1, characterized in that said conductive ball is a shaped part of nonconductive rubber, plastic, metal, or sheet metal which is given a conductive plating or a coating of a conductive metal material.

13. A connection structure as set forth in claim 11, characterized in that said conductive ball is hollow.

14. A connection structure as set forth in claim 12, characterized in that said conductive ball is hollow.

15. A connection structure as set forth in claim 1, characterized in that said conductive ball is comprised of a ball-shaped core member, which vaporizes at a high temperature, which is coated with a conductive metal material, then heated to make the center part of the core member vaporize and simultaneously sinter the metal material which is coated on the outer circumference.

16. A connection structure as set forth in claim 1, characterized in that said first contact or second contact or both the first and second contacts are elastically supported.
